(19) United States
(12) Patent Application Publication
(10) Pub. No.: US 2020/0244461 A1
(43) Pub. Date: Jul. 30, 2020

(54) Data Processing Method and Apparatus

(71) Applicant: Alibaba Group Holding Limited, Grand Cayman (KY)

(72) Inventors: Peng Xiao, Hangzhou (CN); Yingfang Fu, Beijing (CN)

(21) Appl. No.: 16/776,328

(22) Filed: Jan. 29, 2020

(30) Foreign Application Priority Data
Jan. 30, 2019 (CN) 201910092945.3

(51) Int. Cl. H04L 9/32; G06F 21/72; G06F 21/64; G06F 21/55

(52) U.S. Cl. CPC H04L 9/3234; G06F 21/72; G06F 2221/034; G06F 21/554; G06F 21/64

(57) ABSTRACT

A method including restarting configured measurement objects in an order of chains of trust; measuring characteristic values of the restarted measurement objects one by one and matching the characteristic values with pre-stored trusted reference characteristic values; and performing corresponding operations according to a matching result. The present disclosure resolves the technical problem that a system startup failure may easily occur due to the lack of a complete trusted policy management solution in the conventional techniques.

### CROSS REFERENCE TO RELATED PATENT APPLICATIONS

This application claims priority to Chinese Patent Application No. 201910092945.3, filed on 30 Jan. 2019 and entitled “Data Processing Method and Apparatus,” which is incorporated herein by reference in its entirety.

### TECHNICAL FIELD

The present disclosure relates to the field of cryptographic operations, and, more particularly, to data processing methods and apparatuses.

### BACKGROUND

In conventional techniques, the Trusted Platform Model (TPM) trusted standard of Trusted Computing Group (TCG) does not provide a process for verifying the measurement object integrity and can only verify whether the measurement value of each measurement object is equal to the trusted reference value after the startup is complete. Moreover, in conventional techniques, the method of adding a trusted verification process of the measurement object integrity to the TCG/TPM standard can be used to perform the trusted verification of the measurement object. For example, the hash value of the measurement object is compared with the trusted standard value stored in the trusted nonvolatile (NV) space. The trusted reference hash value is stored in the NV space. The hash of the measurement object, however, changes due to the upgrade, update, or patch of the measurement object, which causes integrity verification failure.

Regarding the foregoing problem that a system startup failure may easily occur due to the lack of a complete trusted policy management solution in the conventional techniques, no effective solution has been proposed at present.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Example embodiments of the present disclosure provide data processing methods and apparatuses for at least resolving the technical problem that a system startup failure may easily occur due to the lack of a complete trusted policy management solution in the conventional techniques.

According to an example embodiment of the present disclosure, a data processing method is provided, comprising restarting configured measurement objects in an order of chains of trust; measuring characteristic values of the restarted measurement objects one by one, matching the characteristic values with pre-stored trusted reference characteristic values; and performing corresponding operations according to a matching result.

According to another example embodiment of the present disclosure, a data processing apparatus is further provided, comprising: a restart module configured to restart configured measurement objects in an order of chains of trust; a verification module configured to measure characteristic values of the restarted measurement objects one by one, and match the characteristic values with pre-stored trusted reference characteristic values; and a management module configured to perform corresponding operations according to a matching result.

According to another example embodiment of the present disclosure, a data processing method is further provided, comprising: restarting configured measurement objects in an order of chains of trust; performing integrity verification on the restarted measurement objects one by one; and performing corresponding operations according to a verification result.

According to another example embodiment of the present disclosure, a storage medium such as memory is further provided; the storage medium comprises a stored program or computer-readable instructions, wherein the program is run to control a device in which the storage medium is located to perform the foregoing data processing method.

In the example embodiments of the present disclosure, the configured measurement objects are restarted in an order of chains of trust; the characteristic values of the restarted measurement objects are measured one by one; the characteristic values are matched with the pre-stored trusted reference characteristic values; and the corresponding operation is performed according to a matching result. By inspecting the characteristic values of each measurement object in the chain of trust, the present disclosure achieves the objects of effectively inspecting the confidence level of the measurement object in the chain of trust, so as to achieve the technical effects of improving the confidence level of the system and reducing the probability of a startup failure, thereby resolving the technical problem that a system startup failure may easily occur due to the lack of a complete trusted policy management solution in the conventional techniques.

### BRIEF DESCRIPTION OF DRAWINGS

The drawings described herein are used to provide a further understanding of the present disclosure and constitute a part thereof. The example embodiments of the present disclosure and the descriptions thereof are used to illustrate the present disclosure, and do not constitute an improper limitation on the present disclosure. In the drawings:

FIG. 1 is a block diagram of a hardware structure of a computer terminal of a data processing method according to an example embodiment of the present disclosure;

FIG. 2 is a flowchart of trusted chain transfer in the conventional techniques;

FIG. 3 is a flowchart of trusted integrity verification in the conventional techniques;

FIG. 4 is a flowchart of a data processing method according to Example embodiment 1 of the present disclosure;

FIG. 5 is a flowchart of a data processing method according to an example embodiment of the present disclosure;

FIG. 6 is a flowchart of a trusted measurement object monitoring method according to an example embodiment of the present disclosure;

FIG. 7 is a flowchart of a system restart monitoring method according to an example embodiment of the present disclosure;

FIG. 8 is a schematic diagram of a data processing apparatus according to Example embodiment 2 of the present disclosure;

FIG. 9 is a flowchart of a data processing method according to Example embodiment 3 of the present disclosure; and

FIG. 10 is a structural block diagram of a computer terminal according to Example embodiment 4 of the present disclosure.

### DETAILED DESCRIPTION

In order to enable those of ordinary skill in the art to better understand the solutions of the present disclosure, the technical solutions in the example embodiments of the present disclosure will be described below in combination with the drawings in the example embodiments of the present disclosure. Apparently, the described example embodiments merely represent some and not all of all the embodiments of the present disclosure. All other embodiments obtained by a person of ordinary skill in the art based on the example embodiments of the present disclosure without involving an inventive effort fall within the protection scope of the present disclosure.

It should be noted that the terms “first” and “second” in the description and claims of the present disclosure and the above drawings are used to distinguish similar objects and are not necessarily intended to describe a specific order or sequence. It should be understood that data used in this way is interchangeable where appropriate, so that the example embodiments of the present disclosure described herein can be implemented in an order other than those illustrated or described herein. In addition, the terms “comprising” and “having” and any variations thereof are intended to cover non-exclusive inclusions. For example, a process, method, system, product, or device that contains a series of steps or units is not necessarily limited to the steps or units explicitly listed, and may instead include other steps or units not explicitly listed or inherent to these processes, methods, products, or devices.

Trusted Computing Group (TCG): an international trusted computing group consists of AMD, Hewlett-Packard, IBM, Intel, Microsoft, or the like.

Trusted Computing: a technology developed and promoted by the TCG It uses a trusted computing platform based on a hardware security module in a computing and communication system to improve the overall security of the system. With trusted computing, the computer will always operate as expected; and this behavior will be jointly guaranteed by means of computer hardware and programs and is implemented by using hardware security modules not accessible to the rest of the system.

Trusted Platform Model (TPM): TPM is an international standard for secure crypto-processors, written by the TCG to protect the hardware by integrating a cryptographic key into the device by means of a dedicated micro-controller. A TPM security chip is a security chip that complies with the TPM standard. It is generally physically bound to a computing platform and can effectively protect a PC and prevent access by unauthorized users.

Trusted Platform Control Model (TPCM): as a self-controllable and trusted node, such as those adopted in China, TPCM is implanted with a trusted source root. Based on the TPM together with the trusted root control function, a password-based active control and measurement is implemented. TPCM is started prior to the CPU and verifies the BIOS, thereby changing the traditional way of thinking TPM as a passive device and achieving an active control of the TPCM to the entire platform.

Platform Configuration Registers (PCR): PCR is provided by trusted security chips, used to store measurement extension values and to prove the platform integrity outside the registers as well as the integrity of measurement logs.

Non-Volatile Space (NV space): a NV space is provided by the trusted security chips. It is used to provide trusted storage for sensitive information, which can be allocated and used by users.

### Example Embodiment 1

According to an example embodiment of the present disclosure, a method example embodiment of a data processing method is further provided. It should be noted that steps shown in the flowchart of the accompanying drawings can be executed in a computer system such as a set of computer-executable instructions. In addition, although a logical order is shown in the flowchart, in some cases, the steps shown or described may be performed in a different order.

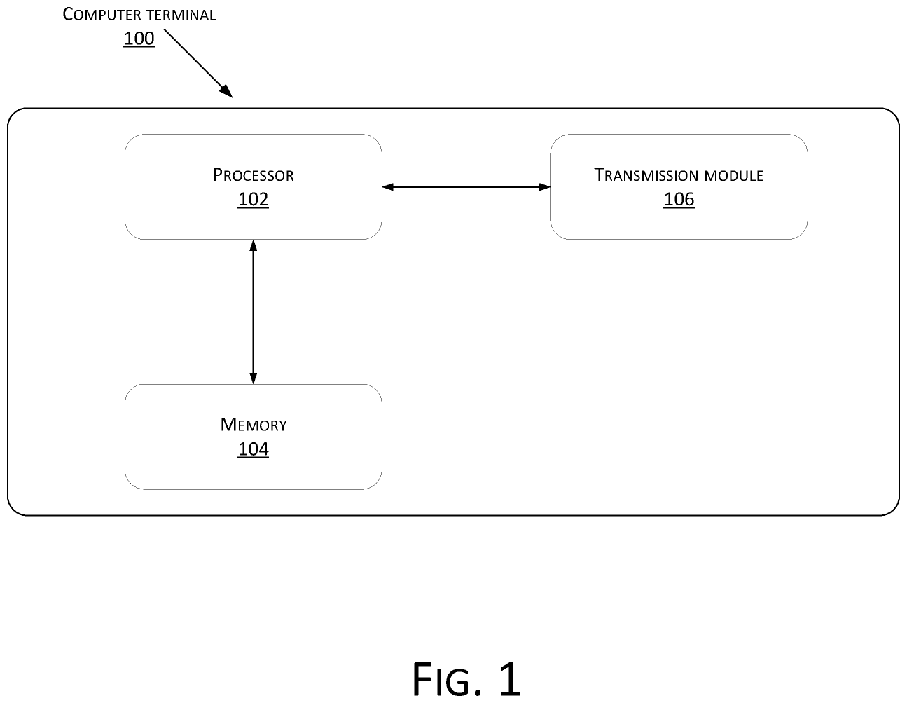

The method example embodiment provided in Example embodiment 1 of the present application may be implemented in a mobile terminal, a computer terminal, or a similar computing device. Taking the operation in a computer terminal as an example, FIG. 1 is a block diagram of a hardware structure of a computer terminal of a data processing method according to an example embodiment of the present disclosure. As shown in FIG. 1, a computer terminal 100 may comprise one or a plurality of processors 102 (only one processor is shown in the drawing, and the processor 102 may include, but is not limited to, a processing device such as a microprocessor MCU or a programmable logic device FPGA), a memory 104 for storing data, and a transmission module 106 for communication functions. A person of ordinary skill in the art can appreciate that the structure shown in FIG. 1 is exemplary and does not impose a limitation on the structure of the electronic device. For example, the computer terminal 100 may alternatively comprise more or fewer components than those shown in FIG. 1 or have a configuration different from that shown in FIG. 1.

A memory 104 may be configured to store software programs and modules of application software, such as computer-readable instructions or modules corresponding to the data processing method in the example embodiment of the present disclosure. The processor 102 runs software programs and modules stored in the memory 104 to perform various functional applications and data processing, namely, implementing the data processing method of the foregoing application program. The memory 104 may comprise a high-speed random-access memory, and may further comprise a non-volatile memory, such as one or a plurality of magnetic storage devices, a flash memory, or other non-volatile solid-state memories. In some examples, the memory 104 may further comprise memories remotely disposed with respect to the processor 102. These remote memories may be connected to the computer terminal 100 through a network. Examples of the foregoing network include, but are not limited to, the Internet, an intranet, a local area network, a mobile communication network, and a combination thereof.

The memory may include volatile memory, random access memory (RAM) and/or non-volatile memory in a computer readable medium, such as read-only memory (ROM) or flash random access memory (flash RAM). The memory is an example of a computer readable medium.

Computer readable media include permanent and non-permanent, removable and non-removable media. Information storage may be implemented by any method or technology. The information may be computer-readable instructions, data structures, modules of programs or other data. Examples of storage media for computers include, but are not limited to, phase-change random access memory (PRAM), static random access memory (SRAM), dynamic random access memory (DRAM), other types of random access memory (RAM), read-only memory (ROM), electrically erasable programmable read only memory (EEPROM), flash memory or other memory technologies, compact disc read-only memory (CD-ROM), digital versatile disc (DVD) or other optical storage, magnetic cassette tape, magnetic disk storage, quantum memory, graphene-based storage media or other magnetic storage devices or any other non-transmission media that may be used to store information that may be accessed by computing devices. As defined herein, the computer readable media do not include transitory computer readable media such as modulated data signals and carrier waves.

A transmission apparatus 106 is configured to receive or transmit data through a network. A specific example of the foregoing network may include a wireless network provided by a communication provider of the computer terminal 100. In an example, the transmission apparatus 106 comprises a Network Interface Controller (NIC), which can be connected to other network devices by using a base station, so as to communicate with the Internet. In one example, the transmission apparatus 106 may be a Radio Frequency (RF) module communicating with the Internet in a wireless manner.

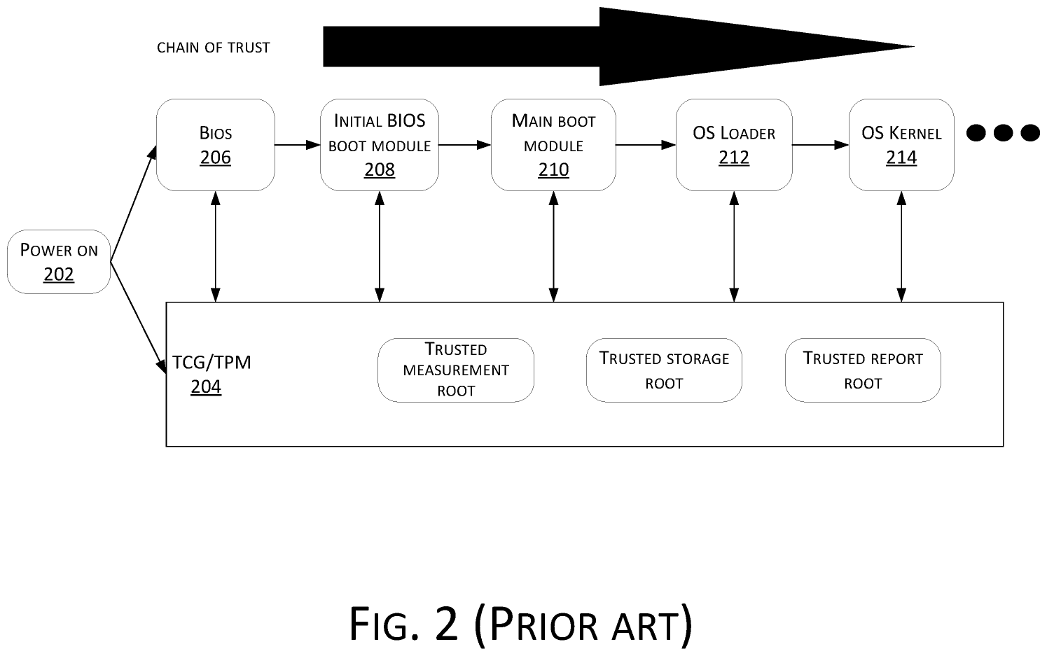

FIG. 2 is a flowchart of trusted chain transfer in conventional techniques. As shown in FIG. 2, after power on at 202, based on the Trusted Computing Group/Trusted Platform Model 204 (TCG/TPM) trusted standard, i.e., TPM is used as the trusted root, a system starts with a trusted measurement root in the BIOS 206 and measures an initial BIOS boot module 208; and then the initial BIOS boot module 208 measures a main BIOS boot module 210; the main BIOS boot module 210 measures the rest of the BIOS and an OS loader 212; and then the OS loader 212 measures an OS kernel 214, and the like. The process continues in this manner, and finally the trusted transfer process from the starting point to the application and network is completed.

The TCG/TPM standard defines the process of establishing a trusted chain and records the measurement value (stored in the PCR space) of each object during the startup process. However, the standard does not provide a process for verifying the measurement object integrity. It can only implement the function of post-examination: after the startup is completed, whether the measurement value of each object is equal to the trusted reference value (stored in the NV space) is examined.

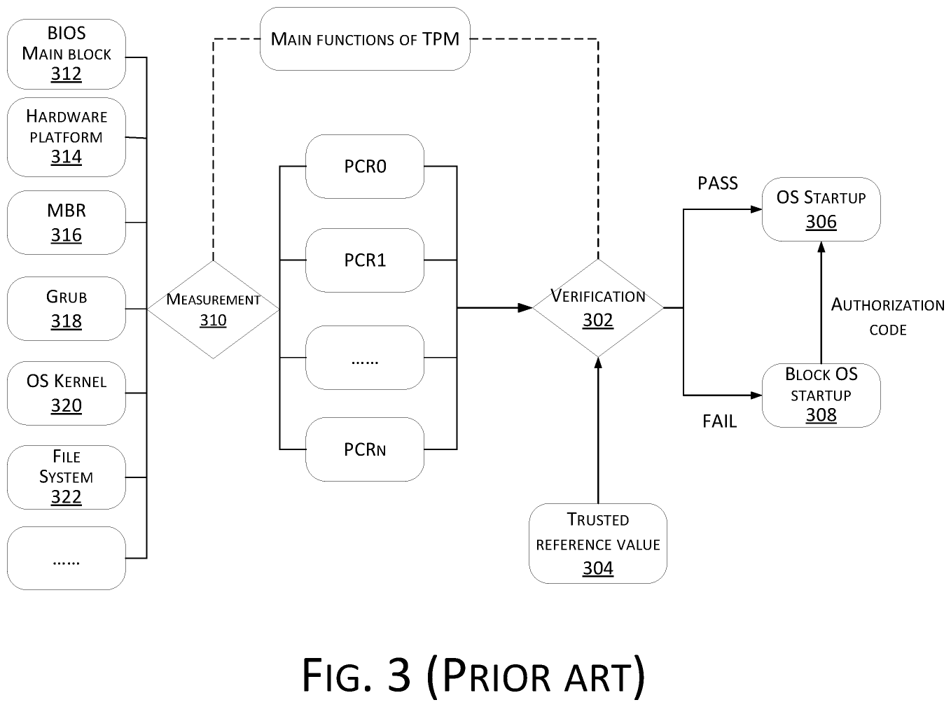

FIG. 3 is a flowchart of trusted integrity verification in conventional techniques. As shown in FIG. 3, a process for trusted verification 302 of the measurement object integrity is added in the TCG/TPM standard. In the startup process (not entering the Operating System (OS)), a normal loading of the OS is stopped (by encryption and decryption of the OS kernel) when the measurement value of a certain object does not match the preset trusted reference value 304. The verification is to compare whether a current hash value of the measurement object is equal to a preset trusted reference hash value. If passing the verification 302, the OS start at 306; if the failing the verification 302, the OS startup is blocked at 308. A measurement 310 can be from a plurality of sources such as a BIOS main block 312, a hardware platform 314, an MBR 316, a grub 318, an OS kernel 320, a file system 322.

In conventional techniques, an OS kernel file is encrypted when an integrity verification policy is deployed. In the system startup process, if the integrity verification of a certain measurement object fails, grub cannot obtain a decryption key of the OS kernel; the OS kernel cannot be loaded successfully, and the startup fails. The OS kernel can only be decrypted and loaded normally when the integrity verification of all measurement objects is successful. In addition, a privilege enforcement startup mode is provided: when the integrity verification fails, the decryption key of the OS kernel can be obtained after a correct privilege code is inputted; the OS kernel is decrypted, loaded, and started (this privileged mode can only be manually inputted under grub).

However, the trusted reference hash value is fixedly stored in the NV space. The upgrade/update/patch and the like of the measurement object each time would lead to a failure in the integrity verification (because the Hash value of the measurement object changes in this case). There is no complete trusted policy management solution in the conventional techniques. If an administrator does not update the trusted reference hash value in the NV space after updating the object (for example, upgrading the OS kernel), the system startup fails at the next startup (because the integrity verification of the measurement object fails). The privilege enforcement startup mode, on the other hand, can only be run manually under grub, which is not suitable for remote and cluster operations.

There exists the problem that a system startup failure may easily occur due to the lack of a complete trusted policy management solution.

Regarding the foregoing problem, this example embodiment provides a data processing method comprising the following steps:

configuring measurement objects in the startup process in a security chip, wherein trusted reference hash values of the measurement objects are configured, and the trusted reference hash values are stored in a storage space of the security chip; and the storage space comprises a non-volatile storage space;

restarting configured measurement objects in an order of chains of trust;

measuring the hash values of the rebooted measurement objects one by one, and matching the hash values with pre-stored trusted reference hash values;

when the hash values are different from the pre-stored trusted reference hash values, the verification fails; blocking the start, and entering a privilege enforcement mode; and when the hash values are the same as the pre-stored trusted reference hash values, monitoring the measurement objects, and performing a system restart monitoring operation.

The monitoring the measurement objects comprises: verifying the hash values; when the verification succeeds, performing a verification process for a measurement object adjacent to the current measurement object; when the verification fails, triggering a system alarm, wherein the system alarm comprises: notifying a system administrator of whether the measurement object is actively updated.

The feedback information of the system alarm is received after the system alarm is triggered. When the feedback information indicates that the measurement object is updated by a system administrator's operation, the trusted reference hash value of the measurement object is updated and stored in a storage space of the security chip; and the verification process of the measurement object adjacent to the current measurement object is performed. When the feedback information indicates that the measurement object is not updated by the system administrator's operation, it is determined that a malicious attack occurs; an intrusion detection operation is performed, and the original unchanged measurement object is restored.

The performing a system restart monitoring operation comprises: starting the system restart monitoring when entering a system call layer and calling a restart system call interface; verifying the hash values; if the verification succeeds, performing the verification process for the measurement object adjacent to the current measurement object; and if the verification fails, triggering a system alarm.

After the system alarm is triggered, the feedback information of the system alarm is received. When the feedback information indicates that the measurement object is not updated by means of the system administrator's operation, the restart process is terminated, and an intrusion detection operation is performed. When the feedback information indicates that the measurement object is updated by means of the system administrator's operation, it is returned to restart the system call interface, and the restart is resumed.

By performing the foregoing steps, the present disclosure achieves the object of effectively inspecting the confidence level of the measurement object in the chain of trust, so as to achieve the technical effects of improving the confidence level of the system and reducing the probability of a startup failure, thereby resolving the technical problem that a system startup failure may easily occur due to the lack of a complete trusted policy management solution in the conventional techniques.

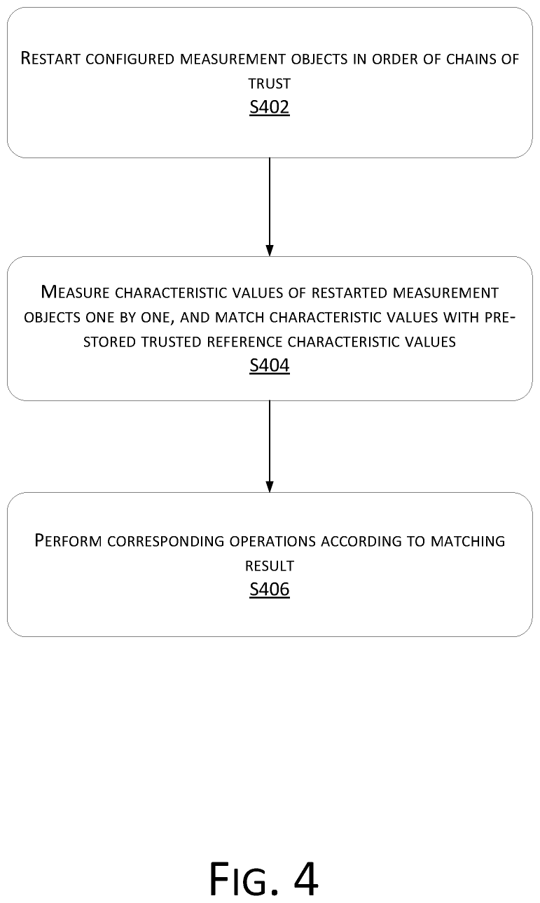

Under the foregoing operating environment, the present application provides a data processing method as shown in FIG. 4. FIG. 4 is a flowchart of a data processing method according to an example embodiment of the present disclosure. As shown in FIG. 4, the specific steps are as follows.

Step S402: Restart configured measurement objects in an order of chains of trust.

As an example embodiment, the configured measurement object may be an object that defines the measurement of the security chip TPM/TPCM in the startup process, including, but not limited to, BIOS, OS, key processes, sensitive files, and the like.

As an example embodiment, the foregoing starting in an order of chains of trust may be: measuring the characteristic value of each measurement object in an order of chains of trust. When the characteristic value includes a hash value, the hash value of each independent object is stored in a corresponding PCR. The stored hash value and is then used to match and compare with the trusted reference hash value of each measurement object to determine whether the hash value of the measurement object is the same as the trusted reference hash value, so as to determine whether the measurement object is trusted.

As an example embodiment, the trusted reference hash value of the measurement object may refer to the hash value of each measurement object in the trusted state. For example, the hash values in the trusted states, such as the first operation of the system, the first entry into a computer room, the first impact, and the first installation of applications of the measurement objects can be considered that no attack occurs in these trusted states.

As an example embodiment, the foregoing trusted reference hash value being stored in the NV space of the security chip improves the security of the trusted reference hash values and ensures the confidence level of the trusted reference hash value.

As an example embodiment, an executing body of the foregoing steps may be a security chip. The security chip may be a TPM, a TPCM, or a security trusted module of another system.

As an example embodiment, the foregoing step may be a restarting after receiving a restart command of the system.

Step S404: Measure characteristic values of the restarted measurement objects one by one, and match the characteristic values with pre-stored trusted reference characteristic values.

As an example embodiment, when the characteristic value includes a hash value, the hash value of the current measurement object may be compared with a pre-stored trusted reference hash value in the system restart process. If the hash value is equal to the pre-stored trusted reference hash value, it is determined that the hash value of the current measurement object is trusted.

As an example embodiment, when the characteristic value includes a hash value and if the hash value of the current measurement object is different from the trusted reference hash value, it indicates that the integrity verification of the current measurement object fails; and it can be considered that the current measurement object is tampered, and remedial measures can be taken; responses such as deleting tampered content, isolating tampered content, and system alarm may be made.

As an example embodiment, the hash value of the measurement object may be measured by means of a hash measurement algorithm, such as SHA-1 algorithm, SHA256 algorithm, and SM3 algorithm.

Step S406: Perform corresponding operations according to a matching result.

As an example embodiment, the foregoing corresponding operation may be: when the hash value is the same as the pre-stored trusted reference hash value, the measurement object may be monitored, and/or the system restart monitoring operation may be performed.

As an example embodiment, the monitoring the measurement object may be inspecting whether a trusted measurement object has changed, whether a performed change operation is authorized/trusted, or whether the change operation is a system administrator's operation.

As an example embodiment, in the system restart monitoring operation, the hash value of the current measurement object may be compared with a pre-stored trusted reference hash value; if the hash value is equal to the pre-stored trusted reference hash value, it is determined that the hash value of the current measurement object is trusted; the system administrator is prevented from changing the measurement object; and it is determined that the trusted reference of the measurement object is not updated, which prevents the following problem from happening: that the trusted integrity verification cannot be performed on the system in the next startup process. The trusted integrity verification process for the system can thus be ensured to be performed in the next startup process.

As an example embodiment, the foregoing corresponding operation may alternatively be: when the hash value is different from the pre-stored trusted reference hash value, the system may be controlled to block the starting and the system entering the privilege enforcement mode. For example, users with lower privileges is prohibited to access; and only privileged users with higher security levels are allowed to access and operate.

By performing the foregoing steps, the present application is able to restart the configured measurement objects in an order of chains of trust; the hash values of the restarted measurement objects are measured one by one; the hash values are matched with the pre-stored trusted reference hash values, and the corresponding operation is performed according to a matching result. By inspecting the hash values of each measurement object in the chain of trust, the present application achieves the object of effectively inspecting the confidence levels of the measurement objects in the chain of trust, so as to achieve the technical effects of improving the confidence level of the system and reducing the probability of a startup failure, thereby resolving the technical problem that a system startup failure may easily occur due to the lack of a complete trusted policy management solution in the conventional techniques.

As an example embodiment, before the restarting configured measurement objects in the order of chains of trust, the method further comprises: configuring a measurement object in the startup process in a security chip, wherein a trusted reference hash value of the measurement object is configured and stored in a storage space of the security chip; and the storage space comprises a non-volatile storage space.

As an example embodiment, the configuration of the measurement objects in the security chip may be: defining the measurement objects according to the measurement requirements of the security chip during startup, and determining the measurement order of the measurement objects according to the trusted chains.

As an example embodiment, when the foregoing measurement object is configured, a trusted reference hash value of the measurement object that needs to be used in the measurement process can also be configured. The foregoing trusted reference hash value is stored in a trusted storage space of the security chip.

As an example embodiment, the trusted storage space may be a non-volatile storage space to ensure storage stability of the trusted reference hash value.

As an example embodiment, the performing corresponding operations according to a matching result comprises: if the hash values are different from the pre-stored trusted reference hash values, the verification fails; blocking the starting, and entering a privilege enforcement mode; and if the hash values are the same as the pre-stored trusted reference hash values, monitoring the measurement objects, and performing a system restart monitoring operation.

As an example embodiment, the foregoing performing corresponding operations according to the matching result may be: determining the measurement object when the hash value is different from the pre-stored trusted reference hash value, which indicates that the verification fails; blocking the starting, and entering a privilege enforcement mode.

In an example embodiment, the foregoing performing corresponding operations according to the matching result may alternatively be: when the hash value is the same as the pre-stored trusted reference hash value, monitoring the measurement objects, and/or performing operations such as the system restart monitoring operation.

As an example embodiment, the monitoring the measurement object comprises: marking a hash value of a current measurement object as a first value; reading a trusted reference hash value of the current measurement object stored in the security chip, so as to obtain a second value; determining whether the first value is equal to the second value; if the determination result is positive, the verification succeeds; a verification process for a measurement object adjacent to the current measurement object is performed; and if the determination result is negative, the verification fails; a system alarm is triggered, wherein the system alarm comprises: notifying a system administrator of whether the measurement object is actively updated.

As an example embodiment, in the foregoing process of monitoring the measurement object, the hash value of the current measurement object is compared with the trusted reference hash value corresponding to the current measurement object; when the hash value is equal to the trusted reference hash value, the verification of the current measurement object succeeds; and the verification for the next adjacent measurement object according to the trust chain is performed.

As an example embodiment, when the hash value of the current measurement object is not equal to the trusted reference hash value corresponding to the current measurement object, the verification of the current measurement object fails; and a system alarm is triggered. The foregoing system alarm may be notifying a system administrator of whether the measurement object is actively updated.

As an example embodiment, after the triggering a system alarm, the method further comprises: receiving feedback information of the system alarm; in a case where the feedback information indicates that the measurement object is updated by means of a system administrator's operation, the trusted reference hash value of the measurement object is updated and stored in a storage space of the security chip; and the verification process for the measurement object adjacent to the current measurement object is performed; and when the feedback information indicates that the measurement object is not updated by means of a system administrator's operation, determining that a malicious attack occurs; performing an intrusion detection operation, and restoring the original unchanged measurement object.

As an example embodiment, in the process of monitoring the measurement object, after the system alarm is triggered, whether the update of the measurement object is a system administrator's operation is determined according to the feedback information of the system alarm. When the feedback information indicates that the measurement object is updated by means of the system administrator's operation, it is determined that the update of the measurement object is trusted. Then, the trusted reference hash value of the measurement object is updated and stored in the storage space of the security chip; and the verification process for the measurement object adjacent to the current measurement object is performed.

As an example embodiment, when the feedback information indicates that the measurement object is not updated by means of a system administrator's operation, it is determined that the update operation of the measurement object is not trusted; it is determined that a malicious attack occurs; an intrusion detection operation is performed; and the original trusted measurement object, for example, the unchanged measurement object, is restored.

As an example embodiment, the performing a system restart monitoring operation comprises: starting the system restart monitoring when entering a system call layer and calling a restart system call interface; marking a hash value of a current measurement object as a first value; reading a trusted reference hash value of the current measurement object stored in the security chip to obtain a second value; determining whether the first value is equal to the second value; if the determination result is positive, the verification succeeds; a verification process for a measurement object adjacent to the current measurement object is performed; and if the determination result is negative, the verification fails; a system alarm is triggered, wherein the system alarm comprises: notifying a system administrator of whether the measurement object is actively updated.

As an example embodiment, before the system restart monitoring operation is performed, it is determined that the system restart monitoring is started when the system call layer is entered, and the restart system call interface is called. In addition, the system restart monitoring solution needs to be performed using an OS; and the foregoing operating systems include, but are not limited to, Linux, Windows, MacOS, and the like.

As an example embodiment, in the foregoing process of performing the system restart operation, the hash value of the current measurement object is compared with the trusted reference hash value corresponding to the current measurement object; and when the hash value is equal to the trusted reference hash value, the verification of the current measurement object succeeds; and the verification of the next adjacent measurement object according to the trust chain is performed.

As an example embodiment, when the hash value of the current measurement object is not equal to the trusted reference hash value corresponding to the current measurement object, the verification of the current measurement object fails; and a system alarm is triggered. The foregoing system alarm may be notifying a system administrator of whether the measurement object is actively updated.

As an example embodiment, after the triggering a system alarm, the method further comprises: receiving feedback information of the system alarm; in a case where the feedback information indicates that the measurement object is not updated by means of a system administrator's operation, terminating the restart process, and performing an intrusion detection operation; and when the feedback information indicates that the measurement object is updated by means of the system administrator's operation, returning to restart the system call interface, and continuing to perform the restart.

As an example embodiment, in the process of monitoring the measurement object, after the system alarm is triggered, whether the update of the measurement object is a system administrator's operation is determined according to the feedback information of the system alarm. When the feedback information indicates that the measurement object is not updated by means of the system administrator's operation, it is determined that the update operation of the measurement object is not trusted; it is determined that a malicious attack occurs; the system restart process is terminated, and the intrusion detection operation is performed.

As an example embodiment, when the feedback information indicates that the measurement object is updated by means of a system administrator's operation, it is determined that the update of the measurement object is trusted. The system returns to the restart the system call interface, and the restart is continued. It should be noted that an insertion position for the system restart monitoring solution includes, but is not limited to, a reboot system call interface of the system call layer.

It should be noted that this example embodiment further provides an example implementation, which is described in detail below.

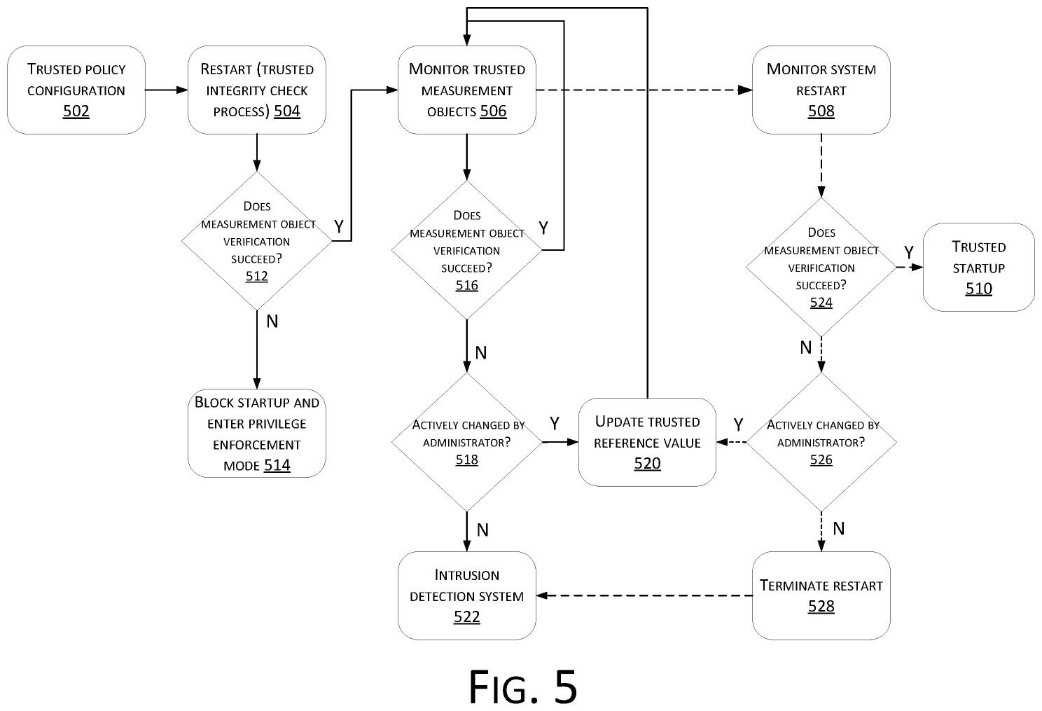

FIG. 5 is a flowchart of a trusted policy management method according to an example embodiment of the present disclosure. As shown in FIG. 5, the trusted policy management solution comprises the following parts: (1) trusted policy configuration 502; (2) restart (trusted integrity verification) 504; (3) Monitor trusted measurement objects 506; (4) Monitor system restart 508; and (5) Trusted startup 510.

(1) trusted policy configuration 502: objects of the security chip TPM/TPCM that need to be measured in the startup process are defined, including, but not limited to, BIOS, OS, key processes, sensitive files, and the like. After the configuration is completed, the hash value of each object will be measured one by one in an order of chains of trust at the next startup and are stored in the corresponding PCR after expansion.

Trusted reference hash values of the measurement objects are defined and stored in the NV space of the security chip. The trusted reference hash values refer to the hash value of each measurement object in the trusted state. In general, the first operation of the system (for example, the first entry into the computer room, the first installation, and the first installation of applications) can be used as the trusted state (assuming that no attacks occur in these occasions).

After the trusted policy configuration is completed, the trusted integrity verification process is started each time the system restarts.

(2) Restart (trusted integrity verification) 504: during restarting, the trusted integrity verification process of the security chip TPM/TPCM is started: calculating the hash value of each measurement object one by one, and comparing the hash value with the trusted reference hash value of the object in the NV space to determine whether the measurement object verification succeeds at 512; if the hash value is not equal to the trusted reference hash value, the integrity verification fails (the measurement object is tampered); blocking the starting of the system, and entering a privilege enforcement mode at 514. If the hash value is not equal to the trusted reference hash value, the process continues to monitor trusted measurement objects 506.

(3) Monitor trusted measurement objects 506: during the normal use and operation phase of the system, it is necessary to monitor the trusted measurement objects and detect changes in the trusted measurement objects in time. At 516, whether the measurement object verification succeeds is determined. If not, at 518, whether the change of the object is actively conducted by a system administrator is determined.

When the change of the measurement object is completed by the system administrator, the trusted reference hash value of the measurement object needs to be updated at 520 to ensure that the trusted integrity verification can be performed at the next startup. When the change is not a system administrator's operation, it indicates that an attack occurs; and the intrusion detection procedure is performed at 522.

Monitoring of trusted measurement objects requires a resident system; and the operating frequency can be customized: an ultra-high frequent operating will consume resource performance, and an ultra-low frequent operating will lead to missed reports.

(4) Monitor system restart 508: when the system has a restart command, at 524, whether the measurement object verification succeeds is determined. The process needs to inspect whether the hash value of the current measurement object is equal to the reference hash value of the measurement object to ensure that the trusted integrity verification process can be performed in the next startup process. If the hash value of the current measurement object is equal to the reference hash value of the measurement object, the process proceeds to the trusted startup 510. If not, at 526, whether the change of the object is actively conducted by a system administrator is determined.

The main purpose is: to prevent the system administrator from changing the measurement object without updating the trusted reference hash value thereof. When the change of the measurement object is completed by the system administrator, the trusted reference hash value thereof needs to be updated to ensure that the trusted integrity verification can be performed at the next startup. When it is not a system administrator's operation, it indicates that an attack occurs; the restart is terminated at 528, and the intrusion detection procedure at 522 is performed.

(5) Trusted startup 510: the system is restarted in a normal procedure when the system restart monitoring process is completed.

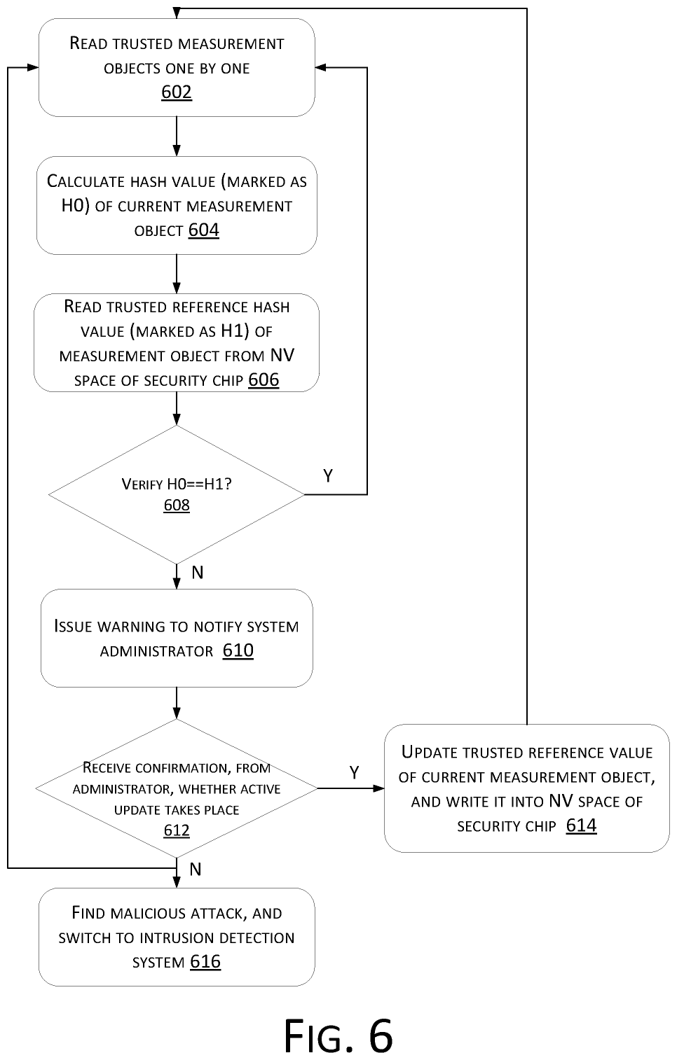

FIG. 6 is a flowchart of a method for monitoring a trusted measurement object according to an example embodiment of the present disclosure. As shown in FIG. 6, the solution for monitoring a trusted measurement object comprises the following parts: At 602, read the trusted measurement objects one by one based on the configured trusted policy, and perform the following trusted measurement object monitoring process. For example, this may be a Linux system restart process:

At 604, calculate the hash value of the current measurement object (marked as H0).

At 606, read the trusted reference hash value of the current measurement object (marked as H1); and read the trusted reference hash value of the current measurement object from the NV space of the security chip TPM/TPCM.

At 608, verify whether H0 is equal to H1: if H0 is equal to H1, the verification succeeds, which proves that the measurement object is not changed; and the loop proceeds to the verification for the next measurement object until all measurement objects are verified. If H0 is not equal to H1, the verification fails, which indicates that the measurement object is modified by someone; and the process proceeds to the next step.

At 610, issue a warning or send a notification alarm to the system administrator: a notification alarm can be sent to the system administrator in various forms, including, but not limited to, system logs, text messages, phone calls, and the like.

At 612, receive confirmation, from the system administrator, whether the measurement object is actively updated: the confirmation methods include, but are not limited to, system log query, administrator response confirmation, object access records, and the like. If the update of the measurement object is an administrator operation, a trusted reference hash value update step is performed at 614. If the update of the measurement object is not an administrator operation, the intrusion detection procedure at 616 is performed.

At 614, update a trusted reference hash value: if the update of the measurement object is an administrator operation, the trusted reference hash value is updated. The trusted reference hash value of the current object is updated and written into the NV space of the security chip TPM/TPCM. The loop proceeds to the verification for the next measurement object until all measurement objects are verified.

At 616, perform intrusion detection procedure: find malicious attack, and switch to intrusion detection system. If the update of the measurement object is not an administrator operation, it indicates that a malicious attack is found; and the intrusion detection procedure is performed. Intrusion detection includes, but is not limited to, log audit, network audit, behavior audit, and other security measures. In addition, the original unchanged measurement object body is restored.

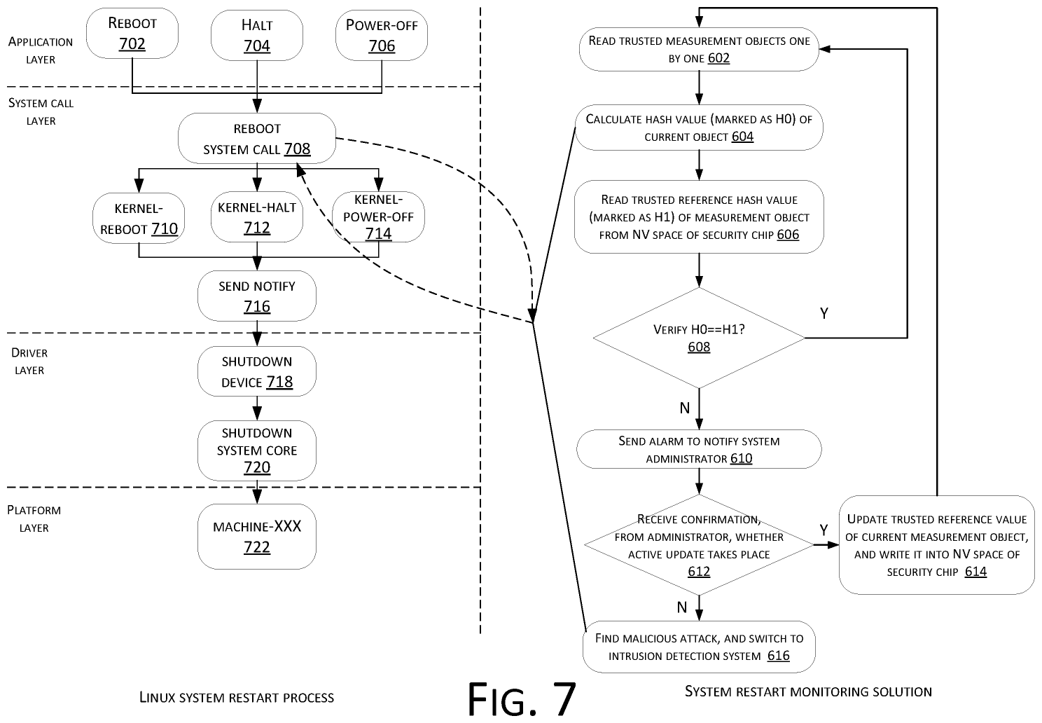

FIG. 7 is a flowchart of a system restart monitoring method according to an example embodiment of the present disclosure. As shown in FIG. 7, the system restart monitoring solution comprises the following parts.

Taking the Linux system as an example, the following is the Linux system restart process.

Application layer: restart instructions, mainly including reboot 702, halt 704, and power-off 706.

System call layer: after the application layer sends a restart instruction, the unified reboot system call interface 708 is called; and the restart instruction enters three different kernel execution functions by using different application layer parameters: kernel_reboot 710, kernel_halt 712, and kernel_power_off 714. After the execution of the kernel execution function ends, a unified system call interface “send notify” 716 is called.

Driver layer: after the system call layer is completed, the driver layer is entered, and “shutdown device” 718 and “shutdown system core” 720 are performed.

Platform layer: the final step is to perform a restart of a physical platform layer. The machine with the name machine-xxx is restarted at 722.

The system restart monitoring solution needs to be inserted into the Linux system restart process. The inserted position includes, but is not limited to, the system call layer (the optimal position). FIG. 7 uses the insertion into the reboot system call interface as an example. Some example steps are as follows.

(1) Application layer restart instructions: reboot, halt, and power-off

(2) Reboot system call interface: when the system call layer is entered and the reboot system call interface is used, the system restart monitoring solution is proceeded.

(3) Enter the system restart monitoring solution: the specific implementation steps are the same as those in the foregoing trusted measurement object monitoring solution. When a measurement object change not by a system administrator's operation is found, the restart process is terminated, and the intrusion detection procedure is performed.

(4) Return to the reboot system call interface: when the system restart monitoring solution does not find any problems, returning to the reboot system call normally.

(5) Continue the system restart process.

This example embodiment provides a trusted measurement object solution, a system restart monitoring solution, and a solution for a hook restart process. Based on the addition of a trusted integrity verification process and a trusted policy management solution, the defects in the conventional techniques where a trusted verification process and policy management are not seen are resolved. In particular, the system restart monitoring solution addresses the problem that the administrator forgets to update the trusted reference hash value in the NV space after updating the measurement object (for example, after upgrading the OS kernel). The security management of trusted policies and the integrity verification of trusted objects can be guaranteed.

### Example Embodiment 2

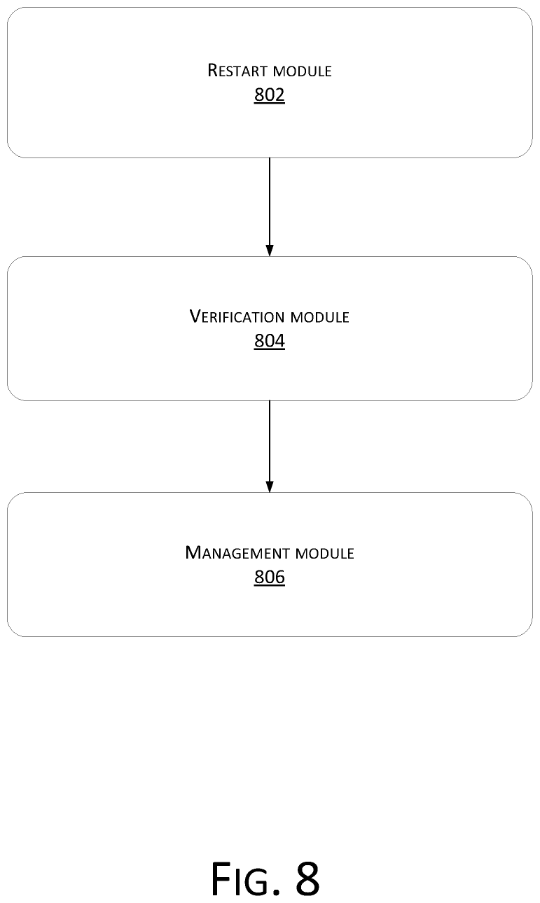

According to another example embodiment of the present disclosure, an apparatus for implementing the trusted policy management method of Example embodiment 1 is further provided. FIG. 8 is a schematic diagram of a data processing apparatus according to Example embodiment 2 of the present disclosure. As shown in FIG. 8, the apparatus comprises a restart module 802, a verification module 804, and a management module 806. The apparatus is described in detail below.

The restart module 802 is configured to restart configured measurement objects in an order of chains of trust. The verification module 804, connected to the restart module 802, is configured to measure characteristic values of the restarted measurement objects one by one, and match the characteristic values with pre-stored trusted reference characteristic values. The management module 806, connected to the verification module 804, is configured to perform corresponding operations according to a matching result.

It should be noted herein that the restart module 802, the verification module 804, and the management module 806 correspond to steps 5402 to 5406 in Example embodiment 1. Examples and application scenarios implemented by the three modules and the corresponding steps are the same, which are not limited to the content disclosed in Example embodiment 1. It should be noted that as a part of the apparatus, the foregoing modules are stored in the memory 104 and executed by the procession 102 in the computer terminal 100 provided in Example embodiment 1.

Example Embodiment 3

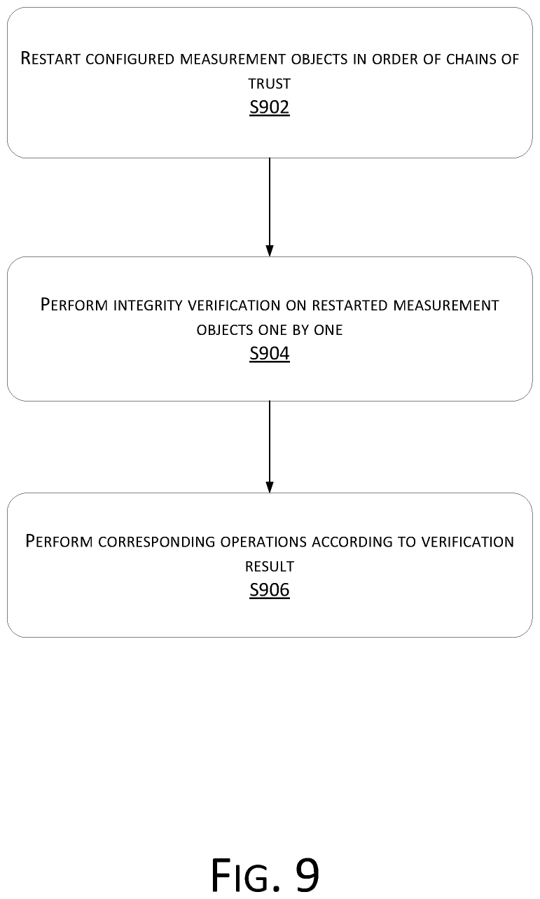

According to another example embodiment of the present disclosure, a data processing method is further provided. FIG. 9 is a flowchart of a data processing method according to Example embodiment 3 of the present disclosure. As shown in FIG. 9, the method comprises the following steps.

Step S902: Restart configured measurement objects in an order of chains of trust.

Step S904: Perform integrity verification on the restarted measurement objects one by one.

Step S906: Perform corresponding operations according to a verification result.

As an example embodiment, the foregoing steps may be performed by a security chip, such as a TPM or a TPCM. The security chip may alternatively be a security system or a security module.

As an example embodiment, the integrity verification achieves the object of effectively inspecting the confidence levels of the measurement objects in the chains of trust, so as to achieve the technical effects of improving the confidence level of the system and reducing the probability of a startup failure, thereby preventing the measurement object in the chain of trust from being tampered, which leads to untrustworthy and resolving the technical problem that a system startup failure may easily occur due to the lack of a complete trusted policy management solution.

As an example embodiment, the integrity verification may be performed by inspecting the hash value of the measurement object, so as to determine whether the hash value of the measurement object is equal to a trusted reference hash value. The foregoing hash value may alternatively be another attribute value used for integrity inspection.

The configured measurement objects are restarted in the order of the chains of trust, the integrity verification is performed on the restarted measurement objects one by one, and the corresponding operations are performed based on the matching result by means of the foregoing steps. By inspecting the hash values of each measurement object in the chain of trust, the present disclosure achieves the object of effectively inspecting the confidence level of the measurement object in the chain of trust, so as to achieve the technical effects of improving the confidence level of the system and reducing the probability of a startup failure, thereby resolving the technical problem that a system startup failure may easily occur due to the lack of a complete trusted policy management solution in the conventional techniques.

It should be noted that for the foregoing method example embodiments, for the sake of a concise description, the method example embodiments are all described as a combination of a series of actions. However, those skilled in the art should know that the present disclosure is not limited thereto. According to the present disclosure, some steps may be performed in another order or simultaneously. In addition, those skilled in the art should also know that the embodiments described in the description are all example embodiments, and the actions and modules involved are not necessarily required by the present disclosure.

Based on the description of the foregoing example embodiments, those skilled in the art can clearly understand that the methods of the foregoing example embodiments can be implemented using software and a needed universal hardware platform, and can certainly be implemented also by using hardware; in many cases, the former is a better implementation however. Based on such an understanding, the part of the technical solution of the present disclosure, which is essential or contributes to the prior art, can be embodied in the form of a software product. The computer software product is stored in a storage medium (such as a ROM/RAM, a magnetic disk, and an optical disk) and includes several instructions for enabling a terminal device (which may be a mobile phone, a computer, a server, a network device, or the like) to execute the method of each example embodiment of the present disclosure.

### Example Embodiment 4

A computer terminal may be provided in an example embodiment of the present disclosure. The computer terminal may be any computer terminal device of a computer terminal group. For example, in this example embodiment, the computer terminal may alternatively be replaced with a terminal device such as a mobile terminal.

For example, in this example embodiment, the computer terminal may be located in at least one of a plurality of network devices in a computer network.

In this example embodiment, the computer terminal can execute program codes of the following steps in a data processing method of an application program: restarting configured measurement objects in an order of chains of trust; measuring characteristic values of the restarted measurement objects one by one, and matching the characteristic values with pre-stored trusted reference characteristic values; and performing corresponding operations according to a matching result.

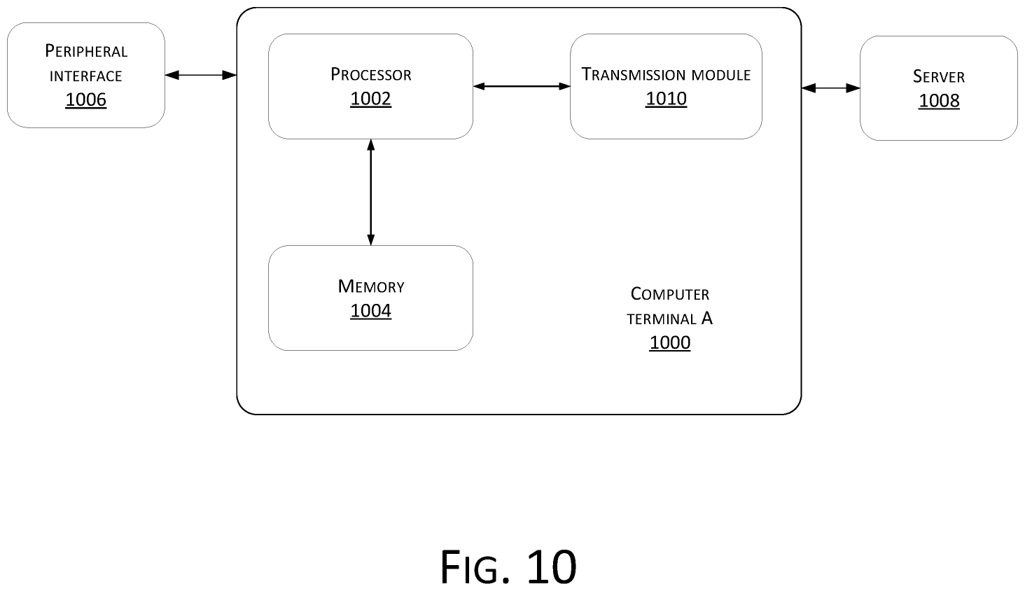

For example, FIG. 10 is a structural block diagram of a computer terminal according to an example embodiment of the present disclosure. As shown in FIG. 10, the computer terminal A 1000 may comprise one or a plurality of processors 1002 (only one processor is shown in the drawing), a memory 1004, and a peripheral interface 1006. The computer terminal A 1000 communicates with a server 1008 via a transmission module 1010.

The memory 1004 can be configured to store software programs and modules, such as computer-readable instructions or modules corresponding to the data processing methods and apparatus in the example embodiments of the present disclosure. The processor 1002 executes various functional applications and data processing by running the software programs and modules stored in the memory, so as to implement the data processing method. The memory 1004 may comprise a high-speed random-access memory, and may further comprise a non-volatile memory, such as one or a plurality of magnetic storage devices, a flash memory, or another non-volatile solid-state memory. In some examples, the memory may further comprise memories remotely disposed with respect to the processor. These remote memories may be connected to the terminal A through a network. Examples of the foregoing network include, but are not limited to, the Internet, an intranet, a local area network, a mobile communication network, and a combination thereof.

The processor 1002 calls the information and the application program stored in the memory by using a transmission apparatus, so as to perform the following steps: restarting configured measurement objects in an order of chains of trust; measuring characteristic values of the restarted measurement objects one by one, and matching the characteristic values with pre-stored trusted reference characteristic values; and performing corresponding operations according to a matching result.

For example, the processor 1002 further executes the program code or computer-readable instructions of the following steps: before the restarting configured measurement objects in the order of trust chains, when the characteristic values include hash values, configuring a measurement object in the startup process in a security chip, wherein a trusted reference hash value of the measurement object is configured; and the trusted reference hash value is stored in a storage space of the security chip; and the storage space comprises a non-volatile storage space.

For example, the processor 1002 further executes the program code of the following steps: the measuring characteristic values of the restarted measurement objects one by one, and matching the characteristic values with pre-stored trusted reference characteristic values comprises: when the characteristic values include hash values, measuring the hash values of the restarted measurement objects one by one, and matching the hash values with pre-stored trusted reference hash values.

For example, the processor 1002 further executes the program code of the following steps: the performing corresponding operations according to a matching result comprises: when the characteristic values include hash values, if the hash values are different from the pre-stored trusted reference hash values, the verification fails; blocking the starting, and entering a privilege enforcement mode; and if the hash values are the same as the pre-stored trusted reference hash values, monitoring the measurement objects, and performing a system restart monitoring operation.

For example, the processor 1002 further executes the program code of the following steps: the monitoring the measurement object comprises: marking a hash value of a current measurement object as a first value; reading a trusted reference hash value of the current measurement object stored in the security chip to obtain a second value; determining whether the first value is equal to the second value; if the determination result is positive, the verification succeeds; a verification process for a measurement object adjacent to the current measurement object is performed; and if the determination result is negative, the verification fails; a system alarm is triggered, wherein the system alarm comprises: notifying a system administrator of whether the measurement object is actively updated.

For example, the processor 1002 further executes the program code of the following steps: receiving the feedback information of the system alarm after the system alarm is triggered; when the feedback information indicates that the measurement object is updated by means of a system administrator's operation, updating the trusted reference hash value of the measurement object and storing the updated trusted reference hash value in a storage space of the security chip; performing the verification process for the measurement object adjacent to the current measurement object; and when the feedback information indicates that the measurement object is not updated by means of a system administrator's operation, determining that a malicious attack occurs; performing an intrusion detection operation, and restoring the original unchanged measurement object.

For example, the processor 1002 further executes the program code of the following steps: the performing a system restart monitoring operation comprises: starting the system restart monitoring when entering a system call layer and calling a restart system call interface; marking a hash value of a current measurement object as a first value; reading a trusted reference hash value of the current measurement object stored in the security chip to obtain a second value; determining whether the first value is equal to the second value; if the determination result is positive, the verification succeeds; performing a verification process for a measurement object adjacent to the current measurement object; and if the determination result is negative, the verification fails; triggering a system alarm, wherein the system alarm comprises: notifying a system administrator of whether the measurement object is actively updated.

For example, the processor 1002 further executes the program code of the following steps: after the system alarm is triggered, receiving the feedback information of the system alarm; when the feedback information indicates that the measurement object is not updated by means of a system administrator's operation, terminating the restart process; and performing an intrusion detection operation; and when the feedback information indicates that the measurement object is updated by the system administrator's operation, returning to restart the system call interface, and continuing to perform the restart.

For example, the processor 1002 further executes the program code of the following steps: restarting configured measurement objects in an order of chains of trust; performing integrity verification on the restarted measurement objects one by one; and performing corresponding operations according to a verification result.

The solution for a data processing method is provided by using the example embodiments of the present disclosure. The configured measurement objects are restarted in an order of chains of trust; the hash values of the restarted measurement objects are measured one by one, and are matched with the pre-stored trusted reference hash values; and the corresponding operation is performed according to a matching result. By inspecting the hash value of each measurement object in the chain of trust, the present disclosure achieves the object of effectively inspecting the confidence levels of the measurement objects in the chain of trust, so as to achieve the technical effects of improving the confidence level of the system and reducing the probability of a startup failure, thereby resolving the technical problem that a system startup failure may easily occur due to the lack of a complete trusted policy management solution in the conventional techniques.

A person of ordinary skill in the art can understand that the structure shown in FIG. 10 is exemplary; and the computer terminal may also be a smart phone (such as an Android phone and an iOS phone), a tablet computer, a palm computer, and a Mobile Internet Device (MID), a PAD, and other terminal devices. The structure of the electronic device is not limited by the illustration of FIG. 10. For example, the computer terminal A 1000 may further comprise more or fewer components (such as a network interface and a display apparatus) than those shown in FIG. 10, or have a configuration different from that shown in FIG. 10.

A person of ordinary skill in the art can understand that all or some of the steps in the various methods of the foregoing example embodiments may be completed by a program instructing related hardware of a terminal device, and the program may be stored in a computer-readable storage medium. The storage medium may comprise a USB flash disk, a Read-Only Memory (ROM), a Random-Access Memory (RAM), a magnetic disk, an optical disk, or the like.

### Example Embodiment 5

An example embodiment of the present disclosure further provides a storage medium. For example, in this example embodiment, the storage medium may be configured to store program code executed by using the data processing method provided in Example embodiment 1.

For example, in this example embodiment, the storage medium can be located in any computer terminal of a computer terminal group in a computer network, or in any mobile terminal of the mobile terminal group.

For example, in this example embodiment, the storage medium is configured to store program code for executing the following steps: restarting configured measurement objects in an order of chains of trust; measuring characteristic values of the restarted measurement objects one by one, and matching the characteristic values with pre-stored trusted reference characteristic values; and performing corresponding operations according to a matching result.

For example, in this example embodiment, the storage medium is configured to store program code for executing the following steps: before the restarting configured measurement objects in the order of chains of trust, when the characteristic values include hash values, configuring a measurement object in the startup process in a security chip, wherein a trusted reference hash value of the measurement object is configured; and the trusted reference hash value is stored in a storage space of the security chip; and the storage space comprises a non-volatile storage space.

For example, in this example embodiment, the storage medium is configured to store program code for executing the following steps: the measuring characteristic values of the restarted measurement objects one by one, and matching the characteristic values with pre-stored trusted reference characteristic values comprises: when the characteristic values include hash values, measuring the hash values of the restarted measurement objects one by one, and matching the hash values with pre-stored trusted reference hash values.

For example, in this example embodiment, the storage medium is configured to store program code for executing the following steps: the performing corresponding operations according to a matching result comprises: when the characteristic values include hash values, if the hash values are different from the pre-stored trusted reference hash values, the verification fails; blocking the starting; and entering a privilege enforcement mode; and if the hash values are the same as the pre-stored trusted reference hash values, monitoring the measurement objects, and performing a system restart monitoring operation.

For example, in this example embodiment, the storage medium is configured to store program code for executing the following steps: the monitoring the measurement object comprises: marking a hash value of a current measurement object as a first value; reading a trusted reference hash value of the current measurement object stored in the security chip to obtain a second value; determining whether the first value is equal to the second value; if the determination result is positive, the verification succeeds; performing a verification process for a measurement object adjacent to the current measurement object; and if the determination result is negative, the verification fails; triggering a system alarm, wherein the system alarm comprises: notifying a system administrator of whether the measurement object is actively updated.

For example, in this example embodiment, the storage medium is configured to store program code for executing the following steps: receiving the feedback information of the system alarm after the system alarm is triggered; when the feedback information indicates that the measurement object is updated by means of a system administrator's operation, updating the trusted reference hash value of the measurement object; storing the updated trusted reference hash value in a storage space of the security chip; and performing the verification process for the measurement object adjacent to the current measurement object; and when the feedback information indicates that the measurement object is not updated by means of a system administrator's operation, determining that a malicious attack occurs; performing an intrusion detection operation, and restoring the original unchanged measurement object.

For example, in this example embodiment, the storage medium is configured to store program code for executing the following steps: the performing a system restart monitoring operation comprises: starting the system restart monitoring when entering a system call layer and calling a restart system call interface; marking a hash value of a current measurement object as a first value; reading a trusted reference hash value of the current measurement object stored in the security chip to obtain a second value; determining whether the first value is equal to the second value; if the determination result is positive, the verification succeeds; performing a verification process for a measurement object adjacent to the current measurement object; and if the determination result is negative, the verification fails; triggering a system alarm, wherein the system alarm comprises: notifying a system administrator of whether the measurement object is actively updated.

For example, in this example embodiment, the storage medium is configured to store program code for executing the following steps: after the system alarm is triggered, receiving the feedback information of the system alarm; when the feedback information indicates that the measurement object is not updated by means of a system administrator's operation, terminating the restart process; and performing an intrusion detection operation; and when the feedback information indicates that the measurement object is updated by means of the system administrator's operation, returning to restart the system call interface, and continuing to perform the restart.

For example, in this example embodiment, the storage medium is configured to store program code for executing the following steps: restarting configured measurement objects in an order of chains of trust; performing integrity verification on the restarted measurement objects one by one; and performing corresponding operations according to a verification result.

The serial numbers of the example embodiments of the present disclosure are merely for description, and do not represent the advantages and disadvantages of the example embodiment.

In the foregoing example embodiments of the present disclosure, the description of each example embodiment has its own emphasis. For a part that is not described in detail in an example embodiment, reference may be made to related descriptions in other example embodiments.

In the several example embodiments provided in the present application, it should be understood that the disclosed technical content may be implemented in other ways. The apparatus example embodiment described above is only schematic. For example, the division of units is only a logical function division. In actual implementation, another division manner may be used. For example, a plurality of units or components may be combined or may be integrated into another system; or some features can be ignored or not implemented. In addition, the displayed or discussed mutual coupling, direct coupling, or communication connection may be indirect coupling or communication connection by means of some interfaces, units, or modules, which may also be electrical or other forms.

The units described as separate components may or may not be physically separated; and the components displayed as units may or may not be physical units; that is, the units may be located in one place, or may be distributed on a plurality of network units. Some or all of the units may be selected according to actual needs to achieve the object of the solution of this example embodiment.

In addition, each functional unit in each example embodiment of the present disclosure may be integrated into a processing unit, or each unit may exist separately physically, or two or more units may be integrated into one unit. The above integrated unit may be implemented in the form of hardware or in the form of a software functional unit.

If the integrated unit is implemented in the form of a software functional unit and sold or used as an independent product, it may be stored in a computer-readable storage medium. Based on such an understanding, the part of the technical solution of the present application, which is essential or contributes to the prior art, can be embodied in the form of a software product. The computer software product is stored in a storage medium and includes several instructions for enabling a terminal device (which may be a personal computer, a server, a network device, or the like.) to execute all or some of the steps of the method according to each example embodiment of the present application. The aforementioned storage media include a USB flash disk, a ROM, a RAM, a removable hard disk, a magnetic disk, or an optical disk, and other media that can store program code.

The above are merely example embodiments of the present disclosure. It should be noted that for a person of ordinary skill in the art, several improvements and modifications may be made without departing from the principles of the present disclosure. These improvements and modifications should also be deemed as falling within the protection scope of the present disclosure.

The present disclosure may further be understood with clauses as follows.

Clause 1 A data processing method, comprising:

restarting configured measurement objects in an order of chains of trust;

measuring characteristic values of the restarted measurement objects one by one, and matching the characteristic values with pre-stored trusted reference characteristic values; and

performing corresponding operations according to a matching result.

Clause 2. The method according to clause 1, wherein before the restarting configured measurement objects in an order of chains of trust, the method further comprises:

when the characteristic value comprises a hash value, configuring a measurement object in a startup process in a security chip, wherein a trusted reference hash value of the measurement object is configured, and the trusted reference hash value is stored in a storage space of the security chip; and the storage space comprises a non-volatile storage space.

Clause 3. The method according to clause 1, wherein the measuring characteristic values of the restarted measurement objects one by one, and matching the characteristic values with pre-stored trusted reference characteristic values comprises:

when the characteristic values comprise hash values, measuring the hash values of the restarted measurement objects one by one, and matching the hash values with pre-stored trusted reference hash values.

Clause 4. The method according to any one of clauses 1 to 3, wherein the performing corresponding operations according to a matching result comprises:

in a case when the characteristic values comprise hash values, if the hash values are different from the pre-stored trusted reference hash values, a verification fails, blocking the starting, and entering a privilege enforcement mode; and

if the hash values are the same as the pre-stored trusted reference hash values, monitoring the measurement objects, and performing a system restart monitoring operation.

Clause 5. The method according to clause 4, wherein the monitoring the measurement object comprises:

marking a hash value of a current measurement object as a first value;

reading a trusted reference hash value of the current measurement object stored in the security chip to obtain a second value;

determining whether the first value is equal to the second value;

if the determination result is positive, the verification succeeds, performing a verification process for a measurement object adjacent to the current measurement object; and

if the determination result is negative, the verification fails, triggering a system alarm, wherein the system alarm comprises notifying a system administrator of whether the measurement object is actively updated.

Clause 6. The method according to clause 5, wherein after the triggering a system alarm, the method further comprises:

receiving feedback information of the system alarm;

in a case where the feedback information indicates that the measurement object is updated by means of a system administrator's operation, updating the trusted reference hash value of the measurement object, storing the updated trusted reference hash value in the storage space of the security chip, and performing a verification process for a measurement object adjacent to the current measurement object; and

in a case where the feedback information indicates that the measurement object is not updated by means of a system administrator's operation, determining that a malicious attack occurs, performing an intrusion detection operation, and restoring the original unchanged measurement object.

Clause 7. The method according to clause 4, wherein the performing a system restart monitoring operation comprises:

starting the system restart monitoring when entering a system call layer and calling a restart system call interface;

marking a hash value of a current measurement object as a first value;

reading a trusted reference hash value of the current measurement object stored in the security chip to obtain a second value;

determining whether the first value is equal to the second value;

if the determination result is positive, the verification succeeds, performing a verification process for a measurement object adjacent to the current measurement object; and

if the determination result is negative, the verification fails, triggering a system alarm, wherein the system alarm comprises notifying a system administrator of whether the measurement object is actively updated.

Clause 8. The method according to claim 7, wherein after the triggering a system alarm, the method further comprises:

receiving feedback information of the system alarm;

when the feedback information indicates that the measurement object is not updated by means of the system administrator's operation, terminating the restart process, and performing an intrusion detection operation; and

when the feedback information indicates that the measurement object is updated by means of the system administrator's operation, returning to the restart system call interface, and continuing to perform the restart.

Clause 9. A data processing apparatus, comprising:

a restart module, configured to restart configured measurement objects in an order of chains of trust;

a verification module, configured to measure characteristic values of the restarted measurement objects one by one, and match the characteristic values with pre-stored trusted reference characteristic values; and

a management module configured to perform corresponding operations according to a matching result.

Clause 10. The apparatus according to claim 9, wherein the management module comprises:

a first management unit, configured to: in a case where the characteristic values comprise hash values, if the hash values are different from the pre-stored trusted reference hash values, a verification fails; block the starting, and enter a privilege enforcement mode; and

a second management unit, configured to: in a case where the hash values are the same as the pre-stored trusted reference hash values, monitor the measurement object, and perform a system restart monitoring operation.

Clause 11. A data processing method, comprising:

restarting configured measurement objects in an order of chains of trust;

performing integrity verification on the restarted measurement objects one by one; and

performing corresponding operations according to a verification result.

Clause 12. A storage medium, comprising a program stored therein which, when run, controls a device where the storage medium locates to execute the data processing method according to claim 1 or 10.

What is claimed is:

1. A method comprising:
restarting one or more measurement objects in an order of chains of trust;
measuring characteristic values of the restarted measurement objects; and
matching the characteristic values with pre-stored trusted reference characteristic values; and
performing a corresponding operation according to a matching result.

2. The method of claim 1, wherein the measurement objects are configured.

3. The method of claim 1, wherein the measuring characteristic values of the restarted measurement objects comprises measuring the characteristic values of the restarted measurement objects one by one.

4. The method of claim 1, wherein before the restarting the measurement objects in the order of chains of trust, the method further comprises:
determining that the characteristic value comprises a hash value; and
configuring a measurement object in a startup process in a security chip.

5. The method of claim 4, wherein the configuring the measurement object in the startup process in a security chip comprises
configuring a trusted reference hash value of the measurement object; and
storing the trusted reference hash value in a storage space of the security chip.

6. The method of claim 5, wherein the storage space comprises a non-volatile storage space.

7. The method of claim 1, wherein the characteristic values comprise hash values.

8. The method of claim 7, wherein the measuring the characteristic values of the restarted measurement objects comprises measuring the hash values of the restarted measurement objects.

9. The method of claim 8, wherein the matching the characteristic values with pre-stored trusted reference characteristic values comprises matching the hash values with pre-stored trusted reference hash values.

10. The method of claim 7, wherein the performing the corresponding operation according to the matching result comprises:
determining that the hash values are different from the pre-stored trusted reference hash values;
determining that a verification fails.

11. The method of claim 10, further comprising:
blocking a starting; and
entering a privilege enforcement mode.

12. The method of claim 7, wherein the performing the corresponding operation according to the matching result comprises:
determining that the hash values are the same as the pre-stored trusted reference hash values;
monitoring the measurement objects; and
performing a system restart monitoring operation.

13. The method of claim 12, wherein the monitoring the measurement objects comprises:
marking a hash value of a current measurement object as a first value;
reading a trusted reference hash value of the current measurement object stored in a security chip to obtain a second value;
determining that the first value is equal to the second value;
determining that a verification succeeds; and
performing a verification process for a measurement object next to the current measurement object.

14. The method of claim 12, wherein the monitoring the measurement objects comprises:
marking a hash value of a current measurement object as a first value;
reading a trusted reference hash value of the current measurement object stored in a security chip to obtain a second value;
determining that the first value is not equal to the second value;
determining that a verification fails; and
triggering a system alarm.

15. The method of claim 14, wherein:
the triggering the system alarm comprises notifying a system administrator whether the measurement object is actively updated.
after the triggering the system alarm, the method further comprises:
receiving feedback information of the system alarm;
determining that the feedback information indicates that the current measurement object is updated by a system administrator's operation;
updating the trusted reference hash value of the current measurement object; and
storing the updated trusted reference hash value in a storage space of the security chip.

16. The method of claim 14, wherein:
the triggering the system alarm comprises notifying a system administrator whether the measurement object is actively updated.
after the triggering the system alarm, the method further comprises:
receiving feedback information of the system alarm;
determining the feedback information indicates that the current measurement object is not updated by a system administrator's operation;
determining that a malicious attack occurs;
performing an intrusion detection operation; and
restoring an originally unchanged measurement object.

17. The method of claim 12, wherein the performing the system restart monitoring operation comprises:
starting the system restart monitoring when entering a system call layer and calling a restart system call interface;
marking a hash value of a current measurement object as a first value;
reading a trusted reference hash value of the current measurement object stored in a security chip to obtain a second value;
determining whether the first value is equal to the second value; and
in response to determining that the first value is equal to the second value, determining that a verification succeeds; or
in response to determining that the first value is not equal to the second value, determining that the verification fails and triggering a system alarm, wherein the system alarm comprises notifying a system administrator of whether the measurement object is actively updated.

18. The method of claim 17, wherein after the triggering the system alarm, the method further comprises:
receiving feedback information of the system alarm; and
when the feedback information indicates that the current measurement object is not updated by a system administrator's operation, terminating the restart process and performing an intrusion detection operation; or
when the feedback information indicates that the current measurement object is updated by the system administrator's operation, returning to the restart system call interface and continuing to perform the restart.

19. A computer terminal comprising:
one or more processors; and
one or more computer readable media storing computer-readable instructions that, executable by the one or more processors, cause the one or more processors to perform acts comprising:
restarting one or more measurement objects in an order of chains of trust;
measuring characteristic values of the restarted measurement objects one by one; and
matching the characteristic values with pre-stored trusted reference characteristic values; and
performing a corresponding operation according to a matching result.

20. One or more computer readable media storing computer-readable instructions that, executable by one or more processors, cause the one or more processors to perform acts comprising:
restarting one or more measurement objects in an order of chains of trust;
measuring characteristic values of the restarted measurement objects, the characteristic values including hash values; and
matching the characteristic values with pre-stored trusted reference characteristic values; and
performing a corresponding operation according to a matching result.
